(19) United States
(12) Patent Application Publication
(10) Pub. No.: US 2026/0195619 A1
(43) Pub. Date: Jul. 9, 2026

(54) MULTI-AI AGENT COLLABORATIVE CREATIVITY ASSISTANCE SYSTEM

(71) Applicant: NATIONAL YUNLIN UNIVERSITY OF SCIENCE AND TECHNOLOGY, Yunlin County (TW)

(72) Inventor: YA-KUAN CHOU, Yunlin County (TW)

(73) Assignee: NATIONAL YUNLIN UNIVERSITY OF SCIENCE AND TECHNOLOGY, Yunlin County (TW)

(21) Appl. No.: 19/391,438

(22) Filed: Nov. 17, 2025

(30) Foreign Application Priority Data
Jan. 9, 2025 (TW) 114100959

(51) Int. Cl. G06N 5/043; H04L 12/18

(52) U.S. Cl. CPC G06N 5/043; H04L 12/1818; H04L 12/1822; H04L 12/1831

(57) ABSTRACT

A multi-AI agent collaborative creativity assistance system includes a user interface module, a multi-AI agent module, and a collaborative generation module. The user interface module is used to set an AI agents number participating a meeting and a topic, and support real-time interaction. The multi-AI agent module includes multiple AI agent units and an expertise configuration unit. The expertise configuration unit is used to set an expertise background of AI agent units, so that each AI agent unit accordingly performs input and output and dynamically generates the result on the display device. The collaborative generation module processes the inputs and outputs of AI agent units in real time, thereby keeping them consistent with the topic. Each AI agent unit performs professional division and collaborative operation, and users can participate at any time, effectively simulating a team brainstorming process and providing diverse and dynamic suggestions.

### BACKGROUND OF THE DISCLOSURE

### Field of the Disclosure

The present disclosure relates to Artificial Intelligence (AI) assistance systems, and more particularly, to a multi-AI agent collaborative creativity assistance system.

### Description of the Related Art

Regarding team collaboration, conventional creative teams require a large amount of manpower and resources for recruitment, coordination, and adaptation, which often leads to communication barriers, and is greatly constrained by location and time.

Currently existing AI-assisted systems are mostly based on a single Artificial Intelligence (AI) or rule-driven mechanisms, which are unable to realize collaborative operation between multiple AIs and lack support for different professional fields, failing to simulate the multi-perspective discussion effects of professional teams, leading to generated suggestions that are singular and lacking in diversity and in-depth interaction. As a result, development and application potential of AI assistance is often limited.

### SUMMARY OF THE DISCLOSURE

The present disclosure aims at addressing the inefficiencies in conventional team collaboration, the overly singular nature of suggestions generated by a single Artificial Intelligence (AI), the lack of collaborative capabilities, and the incapability of providing real-time adjustments and dynamic generation of suggestions.

For achieving the aforementioned objectives, A multi-AI agent collaborative creativity assistance system, which is executed by a processor and displayed on a display device, comprising:

a user interface module configured to set a number of AI agents participating a meeting and a meeting topic, and support real-time participation and interaction;

a multi-AI agent module connected to the user interface module, the multi-AI agent module comprising a plurality of AI agent units and an expertise configuration unit, the plurality of AI agent units being connected to the expertise configuration unit, the expertise configuration unit being configured to set an expertise background of each of the AI agent units, respectively, thereby allowing each of the AI agent units to perform an input and an output according to corresponding expertise backgrounds and dynamically generate the output on the display device; and

a collaborative generation module connected to the multi-AI agent module, the collaborative generation module being configured to process the inputs and the outputs of the plurality of AI agent units in real time, thereby keeping the inputs and the outputs consistent with the meeting topic.

With such configuration, the multi-AI agent collaborative creativity assistance system of the present disclosure effectively simulates the brainstorming process of a team, dynamically outputting multi-perspective and in-depth suggestions via the expertise configuration and collaborative generation of multiple AI agent units, thereby improving the efficiency and breadth of creative ideas generation.

### BRIEF DESCRIPTION OF THE DRAWINGS

FIG. 1 is a structural block diagram of the multi-AI agent collaborative creativity assistance system in accordance with an embodiment of the present disclosure in combination with a processor and a display device.

FIG. 2 is a structural block diagram of the multi-AI agent collaborative creativity assistance system in accordance with an embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

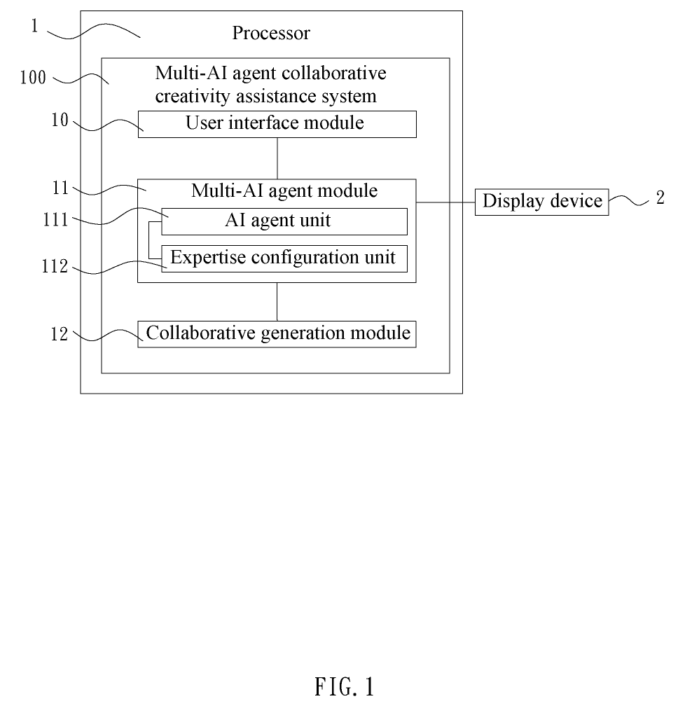

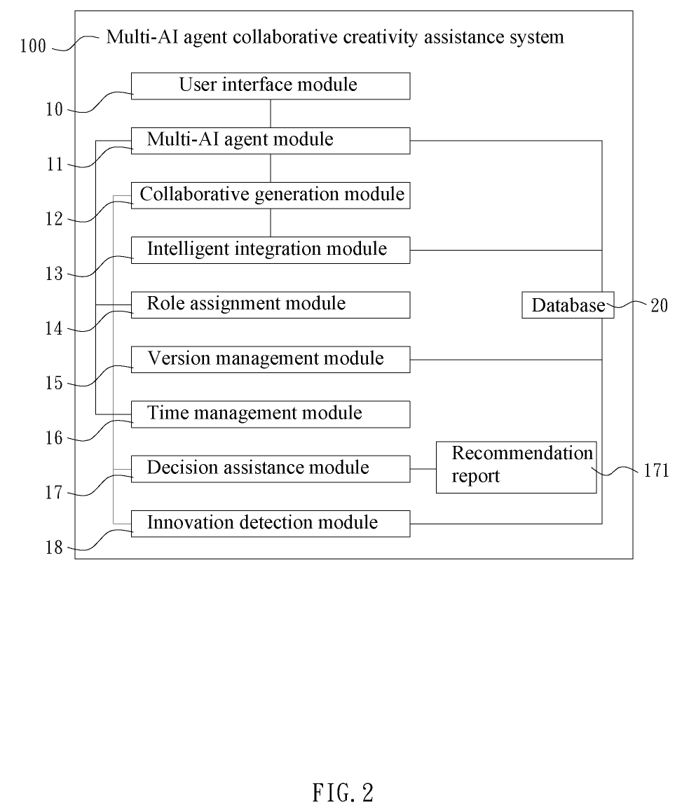

Referring to FIG. 1 and FIG. 2, the present disclosure provides a multi-AI (artificial intelligence) agent collaborative creativity assistance system 100, which is executed by a processor 1 and displayed on a display device 2. The multi-AI agent collaborative creativity assistance system 100 comprises a user interface module 10, a multi-AI agent module 11, and a collaborative generation module 12. The processor 1 serves as a computing unit, which is configured to perform logic operations, data processing, and interactive generation functions of a system, thereby ensuring a smooth operation of the system. The processor 1 is allowed to be a computer CPU, an AI acceleration chip (such as a GPU/TPU), a cloud server processor, or a processor of a tablet or mobile device. The display device 2 serves as a visual output unit of the system and is configured to display the user interface, the discussion content of an AI agent unit 111, and the final generated results in real time. The display device 2 is allowed to be a computer monitor, a tablet screen, a smartphone screen, a large projection device, a virtual reality or augmented reality display, or an electronic touch screen.

The user interface module 10 is configured to set the number of AI (artificial intelligence) agents participating in a meeting and the meeting topic, and to support real-time participation and interaction. In other words, the user interface module 10 allows a user to set the participation conditions for discussion, such as parameters including the meeting topic, the number of AI agent units 111, and role assignment. The user interface module 10 also supports a real-time user participation, enabling the user to flexibly observe the discussion between the plurality of AI agent units 111, insert novel viewpoints, or guide the discussion direction.

The multi-AI agent module 11 is connected to the user interface module 10 and comprises a plurality of AI agent units 111 and an expertise configuration unit 112. The plurality of AI agent units 111 are connected to the expertise configuration unit 112, which is configured to set the expertise background of each AI agent unit 111, such that each AI agent unit 111 performs the output and input based on corresponding expertise background and dynamically generates content on the display device 2. In other words, the plurality of AI agent units 111 within the multi-AI agent module 11 are configured with different expertise backgrounds such as medicine, mechanics, design, or marketing, and each AI agent unit 111 performs analysis and outputs viewpoints according to respective field of expertise, while the expertise configuration unit 112 allows the user to customize the expertise background of each AI agent unit 111. Accordingly, the AI agent units 111 possess specialized knowledge and particular perspectives, so as to be enabled to provide creative suggestions from different point of views and form diverse viewpoints during discussions, thereby facilitating a cross-field collaboration.

The collaborative generation module 12 is connected to the multi-AI agent module 11 and is configured to process the inputs and outputs of the plurality of AI agent units 111 in real time, thereby keeping their inputs and outputs consistent with the meeting topic.

With the above configuration, the collaborative interaction between the plurality of AI agent units 111 simulates the diverse perspectives of a real team, reducing the time and labor costs during communication and coordination, and enhancing the efficiency of meeting discussions.

Referring to FIG. 1 and FIG. 2, the multi-AI agent collaborative creativity assistance system 100 further comprises a database 20 connected to the multi-AI agent module 11. The database 20 contains built-in data related to expertise backgrounds and is able to be connected to external data sources for updates. The database 20 provides a data retrieval function and is configured to store and categorize meeting content. With such configuration, the database 20 supplies the expertise background knowledge required by the plurality of AI agent units 111, so as to ensure that the generated content is professional and in-depth. Also, the database 20 supports dynamic data update to maintain the timeliness and accuracy of system information. Further, the database 20 is capable of storing meeting content, facilitating subsequent data retrieval and analysis.

Referring to FIG. 1 and FIG. 2, the multi-AI agent collaborative creativity assistance system 100 further comprises an intelligent integration module 13 connected to the collaborative generation module 12 and the database 20. The intelligent integration module 13 is configured to collect, filter, and integrate the outputs of the plurality of AI agent units 111, and to transmit those data to the database 20 for storage and categorization. The intelligent integration module 13 is capable of effectively filtering out redundant or invalid information, thereby refining the discussion outcomes.

Referring to FIG. 1 and FIG. 2, the collaborative generation module 12 has an iterative feedback mechanism, which enables the plurality of AI agent units 111 to revise the outputs based on the suggestions exchanged among the AI agent units 111, thereby gradually optimizing the discussion viewpoints.

Referring to FIG. 1 and FIG. 2, the collaborative generation module 12 further has a cross-validation function. The collaborative generation module 12 is configured to examine whether the outputs generated by each AI agent unit 111 has consistency, and to mark similar or contradictory outputs, so as to remind the user of the key differences, thereby helping the user to focus on critical issues and avoiding confusion or misinformation.

Referring to FIG. 1 and FIG. 2, the multi-AI agent collaborative creativity assistance system 100 further comprises a role assignment module 14 connected to the multi-AI agent module 11. The role assignment module 14 is configured to assign roles to each of the AI agent units 111. The roles assigned by the role assignment module 14 include the moderator, multiple supporting side members, multiple opposing side members, and a summarizer.

The AI agent unit 111 responsible for acting as the moderator controls the overall discussion flow, guides the progression of the meeting and ensures that the meeting topic remains focused, and coordinates the interaction between the plurality of AI agent units 111, so as to simulate the guiding function performed by a human moderator.

The AI agent units 111 representing the supporting side may include multiple representatives, and are responsible for presenting arguments supporting a specific position or proposal based on the meeting topic to extend the analysis, and providing detailed data, theoretical foundations, or practical experience based on their expertise background, thereby strengthening the persuasiveness the viewpoint of the supporting side.

The number of AI agent units 111 acting as the opposing side is equal to that of the supporting side. The AI agent units 111 representing the opposing side are responsible for presenting opposing viewpoints, questioning, rebutting, or suggesting alternatives to the arguments of the supporting side, thereby stimulating diverse thinking on the topic, preventing a single viewpoint from dominating the discussion, and promoting creative collisions of ideas.

At the end of the discussion, the AI agent unit 111 representing the summarizer consolidates the viewpoints of both the supporting and opposing sides, extracts the key content, and forms a conclusion, thereby saving the user time from manually organizing the discussion.

With such configuration, by clearly assigning tasks to the AI agent units 111, a real meeting scenario is simulated, such that the opposition between the supporting and opposing sides stimulates diverse viewpoints, which promotes creative thinking.

Referring to FIG. 1 and FIG. 2, the multi-AI agent collaborative creativity assistance system 100 further comprises a version management module 15. The version management module 15 is connected to the database 20 and configured to compare different versions of the meeting content at different stages and mark the differences between the current version and the previous version.

Referring to FIG. 1 and FIG. 2, the multi-AI agent collaborative creativity assistance system 100 further comprises a time management module 16. The time management module 16 is connected to the multi-AI agent module 11 and configured to limit the discussion time of each AI agent unit 111 and ensure that a conclusion on the meeting topic is generated within the designated time, so as to meet the need for decision-making in real time.

Referring to FIG. 1 and FIG. 2, the multi-AI agent collaborative creativity assistance system 100 further comprises a decision assistance module 17. The decision assistance module 17 is connected to the collaborative generation module 12 and configured to provide opinions on the feasibility and potential risks based on the conclusion of the meeting topic and generate a recommendation report 171. Such function assists the user in quickly evaluating the practical feasibility of the conclusion, automatically detecting potential risks, and avoiding overlooking key issues. The automatically generated recommendation report 171 replaces manual writing, reduces the workload of the user, and allows the user to focus on higher-level creativity or decision-making process. The recommendation report 171 is allowed to include visual elements such as charts and key summaries, so as to make the content clearer and easier to read, thereby helping the user to quickly grasp the key points.

Referring to FIG. 1 and FIG. 2, the multi-AI agent collaborative creativity assistance system 100 further comprises an innovation detection module 18 connected to the collaborative generation module 12 and the database 20. The innovation detection module 18 is configured to analyze the content generated by the plurality of AI agent units 111, compare it with currently existing data in the database 20, mark the content having a similarity below a preset threshold, and display that content on the display device 2 in the form of tags. Since the existing data in the database 20 represents prior knowledge and previous meeting results, the comparison between the AI-generated content and the database 20 enables the determination of whether the generated content is novel, and the result is presented as visual tags on the display device 2. Therefore, the user is allowed to efficiently identify high-value innovative content, thus focusing attention on the most valuable perspectives.

Commercial product applications of the multi-AI agent collaborative creativity assistance system 100 of the present disclosure are as follows.

Creative assistance software: the present disclosure is able to be implemented as a standalone desktop or cloud application, enabling the user to configure different AI agent units 111 and access the multi-AI meeting function as needed for creative ideation, quickly obtaining rich suggestions.

Enterprise-level creative meeting platform: the present disclosure is able to be designed as a creativity assistance platform specifically for enterprise teams, allowing companies to utilize the multi-AI agent units 111 for collaborative discussion during product development, marketing planning, and other processes, thereby rapidly generating creative solutions required by the team.

SaaS creative service: the present disclosure is able to be provided as an on-demand software as a service (SaaS) for real-time creative assistance, by which the users conduct creative meetings using the system and are charged based on usage frequency or time.

Integrated creative hardware: for example, the present disclosure is able to be implemented in a smart conference room displaying screen, in which the multi-AI agent collaborative creativity assistance system 100 is embedded, and provided with functions such as meeting moderation and facilitation and automated meeting records.

Educational assistance system: the present disclosure is able to be applied in educational or training institutions to assist creative development of students via the multi-AI agent units 111, thereby helping students better understand and practice creative thinking.

With the aforementioned configuration, the present disclosure achieves following advantages:

The present disclosure provides a flexible configuration of participation conditions. The user interface module 10 is used for setting meeting topic, the number of AI agent units 111, and the assignment of roles, thereby satisfying diverse discussion requirements.

The present disclosure supports real-time human-machine interaction. The user is able to observe discussions between AI agent units 111, introduce viewpoints, or guide the topic, thereby enhancing flexibility and interactivity of human-AI collaboration.

The present disclosure achieves a multi-AI expertise configuration. The expertise configuration unit 112 within the multi-AI agent module 11 allows setting of the expertise background (such as medical, mechanical, design, marketing) for each AI agent unit 111, ensuring that outputs from AI agent units 111 provide creative suggestions from different professional perspectives, promoting cross-field collaboration and diverse viewpoints exchange.

The present disclosure provides a collaborative consistency management. The collaborative generation module 12 processes the inputs and outputs of the AI agent units 111, ensuring that the outputs are consistent with the meeting topic and maintaining the focus of the discussion.

The present disclosure achieves a simulation of real team collaboration. The collaborative interaction of multiple AI agent units 111 simulates the diverse perspectives of a real team, making the discussion process of the AI agent units 111 more realistic and operationally efficient, reducing the time and labor costs associated with communication and adaptation in conventional teams, thereby improving collaboration efficiency.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A multi-AI agent collaborative creativity assistance system, which is executed by a processor and displayed on a display device, comprising:
a user interface module configured to set a number of AI agents participating a meeting and a meeting topic, and support real-time participation and interaction;
a multi-AI agent module connected to the user interface module, the multi-AI agent module comprising a plurality of AI agent units and an expertise configuration unit, the plurality of AI agent units being connected to the expertise configuration unit, the expertise configuration unit being configured to set an expertise background of each of the AI agent units, respectively, thereby allowing each of the AI agent units to perform an input and an output according to corresponding expertise backgrounds and dynamically generate the output on the display device; and
a collaborative generation module connected to the multi-AI agent module, the collaborative generation module being configured to process the inputs and the outputs of the plurality of AI agent units in real time, thereby keeping the inputs and the outputs consistent with the meeting topic.

2. The multi-AI agent collaborative creativity assistance system of claim 1, further comprising a database connected to the multi-AI agent module, wherein the database contains built-in data related to expertise backgrounds and is connectable to external data sources for updates; the database provides a data retrieval function and is configured to store meeting content.

3. The multi-AI agent collaborative creativity assistance system of claim 2, further comprising an intelligent integration module connected to the collaborative generation module and the database, wherein the intelligent integration module is configured to collect, filter, and integrate the outputs of the plurality of AI agent units, and to transmit those data to the database for storage and categorization.

4. The multi-AI agent collaborative creativity assistance system of claim 3, further comprising a version management module connected to the database, wherein the version management module is configured to compare different versions of the meeting content at different stages, and mark differences between a current version and a previous version.

5. The multi-AI agent collaborative creativity assistance system of claim 3, further comprising an innovation detection module connected to the collaborative generation module and the database, wherein the innovation detection module is configured to analyze content generated by the plurality of AI agent units, compare the generated content with currently existing data in the database, mark those content having a similarity below a preset threshold, and display those marked content on the display device in a form of tags.

6. The multi-AI agent collaborative creativity assistance system of claim 1, further comprising a role assignment module connected to the multi-AI agent module, wherein the role assignment module is configured to assign roles to each of the AI agent units; roles assigned by the role assignment module include a moderator, multiple supporting side members, multiple opposing side members, and a summarizer.

7. The multi-AI agent collaborative creativity assistance system of claim 1, further comprising a time management module connected to the multi-AI agent module, wherein the time management module is configured to limit a discussion time of each of the AI agent units, and ensure that a conclusion on the meeting topic is generated by each of the AI agent units within a designated time.

8. The multi-AI agent collaborative creativity assistance system of claim 1, further comprising a decision assistance module connected to the collaborative generation module, wherein the decision assistance module is configured to provide opinions on a feasibility and potential risks based on a conclusion of the meeting topic, and generate a recommendation report.

9. The multi-AI agent collaborative creativity assistance system of claim 1, wherein the collaborative generation module has an iterative feedback mechanism, which enables the plurality of AI agent units to revise the outputs based on suggestions exchanged among the AI agent units.

10. The multi-AI agent collaborative creativity assistance system of claim 1, wherein the collaborative generation module has a cross-validation function, so as to examine whether the outputs generated by each of the AI agent units has consistency, and to mark similar or contradictory outputs.
